(19) United States
(12) Patent Application Publication
(10) Pub. No.: US 2020/0347865 A1
(43) Pub. Date: Nov. 5, 2020

(54) SECTION-STEEL JOINT

(71) Applicant: JING-XIN SOLAR LTD., Tainan City (TW)

(72) Inventor: CHING-LUNG YANG, TAINAN CITY (TW)

(21) Appl. No.: 16/440,022

(22) Filed: Jun. 13, 2019

(30) Foreign Application Priority Data
May 3, 2019 (TW) 108205501

(51) Int. Cl. F16B 7/18; H02S 20/00

(52) U.S. Cl. CPC F16B 7/18; H02S 20/00

(57) ABSTRACT

A section-steel joint serves to fasten a section steel cross beam and a steel beam together. The section-steel joint includes an upright plate, two opposite support portions, and a connecting portion. The two support portions are separated from each other and integratedly connected to the upright plate so that a positioning groove is defined by the two support portions and the upright plate for positioning the section steel cross beam. The connecting portion is located on one side of the positioning groove for positioning the steel beam. With the specially designed positioning groove and connecting portion, the section-steel joint allows the section steel cross beam and the steel beam to be positioned fast, and then fasteners can be used to fix all the components together, thereby making the assembling work more convenient.

### BACKGROUND OF THE INVENTION

### 1. Field of the Invention

The present invention relates to solar power modules, and more particularly to a joint for section steels used in solar power modules.

### 2. Description of the Related Art

A solar power system works by converting sunlight absorbed by solar panels into electricity and storing the electricity for later use. Since a solar power system usually needs large space for setting up solar panels, a common approach to making the most of available space is to install solar panels on roofs of existing buildings outdoor grounds or along the roadside. During the assembling work of a solar power module, quite a number of parts is used in order to well support and fix the steel structures of solar panels (such as the combinations of steel beams and steel columns). However, the conventionally used fastening parts are incompetent and complicated in terms of positioning and assembling, and make it very difficult to adjust the angles of inclination of installed solar panels, adding inconvenience to subsequent use.

### SUMMARY OF THE INVENTION

The primary objective of the present invention is to provide a section-steel joint, which is useful to installation of solar power modules, with the advantages of fast positioning and easy assembling work.

To achieve the foregoing objective, the present invention provides a section-steel joint, which serves to fasten a section steel cross beam and a steel beam together. The section-steel joint comprises an upright plate, two opposite support portions, and a connecting portion. The two support portions are separated from each other and integratedly connected to the upright plate so that a positioning groove is defined by the two support portions and the upright plate for positioning the section steel cross beam. The connecting portion is located on one side of the positioning groove for positioning the steel beam. With the specially designed positioning groove and connecting portion, the section-steel. joint allows the section steel cross beam and the steel beam to be positioned fast, and then fasteners can be used to fix all the components together, thereby making the assembling work more convenient.

Preferably, the two support portions are parallel to and separated from each other while being integratedly connected to the upright plate, and the positioning groove extends transversely while being open at its lateral to receive and position the section steel cross beam.

Preferably, the connecting portion integratedly extending downward from a bottom of the upright plate, and the upright plate is located on one side of the positioning groove, so that fasteners passing through the section steel cross beam and the steel beam before and then being fixed to the connecting portion and the upright plate can combine the section-steel joint with the section steel cross beam and the steel beam as a Whole.

Preferably, the connecting portion is integratedly connected to two opposite sides of one of the support portions so that an accommodating socket is defined by the connecting portion and one of the support portions for accommodating the steel beam.

Preferably, the steel beam is atop provided with two separated fixing tongues, and the connecting portion is fixed to an inner lateral of one of the fixing tongues.

Preferably, a relative angle of inclination is defined by the section-steel joint and the steel beam.

The present invention will be described with reference to some preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

### BRIEF DESCRIPTION OF THE DRAWINGS

FIG. 1 is a perspective view of a first preferred embodiment of the present invention.

FIG. 2 is an exploded view of the first preferred embodiment of the present invention.

FIG. 3 is a perspective view of a second preferred embodiment of the present invention.

FIG. 4 is an exploded view of the second preferred embodiment of the present invention.

### DETAILED DESCRIPTION OF THE INVENTION

It is to be noted first that, throughout the following embodiments and accompanying drawings, like elements or structural features will be identified by identical or similar numbers. The present invention is applicable to various types of solar power module frames and corresponding mounting sites and facilities.

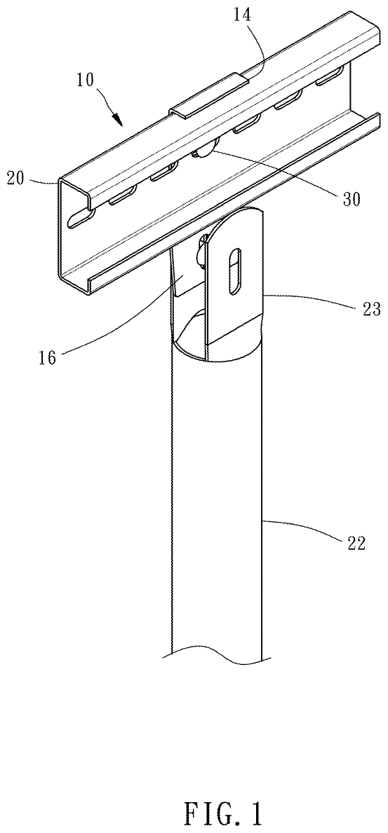

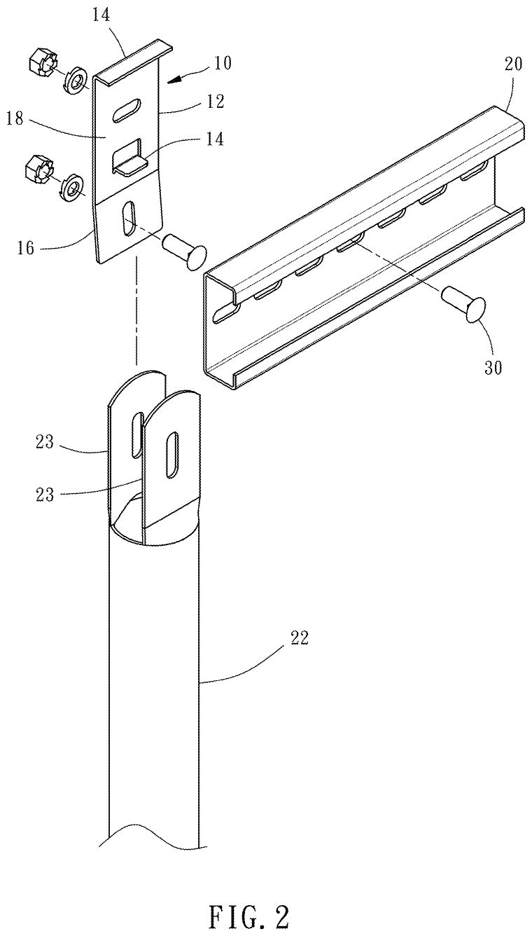

Referring first to FIG. 1 and FIG. 2, in the first preferred embodiment of the present invention, a section-steel joint 10 mainly serves to fasten a section steel cross beam 20 and a steel beam 22. According to the present embodiment, the section steel cross beam 20 is, for example, a C-shaped section steel, and the steel beam 22 has its top provided with two separated fixing tongues 23. The section steel cross beam 20 is transversely mounted on the top of the upstanding steel beam 22, and then the joint 10 is used to fasten the both together.

The disclosed joint 10 comprises an upright plate 12, two opposite and separate support portions 14, and a connecting portion 16. The section-steel joint 10 of the present embodiment is formed by bending a metal sheet in the manner that the two support portions 14 integratedly connected to the upright plate 12 while being parallel to and separated from each other, thereby defining a transversely extending positioning groove 18 between the two support portions 14 and the upright plate 12 for holding the section steel cross beam 20 in position. When assembled, the positioning groove 18 is open to the lateral of the upright plate 12, and the section steel cross beam 20 is transversely received in the positioning groove 18.

According to the present embodiment, the connecting portion 16 is, for example, a plate-like structure. The connecting portion 16 integratedly extends downward from the bottom of the upright plate 12 so that the upright plate 12 is located on one side of the positioning groove 18. The connecting portion 16 is to be fixed to the inner lateral of one of the fixing tongues 23 of the steel beam 22. Fasteners 30 pass through the section steel cross beam 20 and the fixing tongues 23 of the steel beam 22 before fixed to the connecting portion 16 and the upright plate 12 so that the section-steel joint 10 is combined with the section steel cross beam 20 and the steel beam 22 as a whole.

With the aforementioned components, in use of the present invention, the connecting portion 16 of the section-steel joint 10 may be fixed to the top of the steel beam 22 in advance. After the steel beam 22 is well installed at a construction site or on a house roof, the section steel cross beam 20 is fitted into the positioning groove 18 of the section-steel joint 10. To complete the assembling work, the section steel cross beam 20 is fixed to the section-steel joint 10 so that the steel beam 22 and the section steel cross beam 20 are combined with each other.

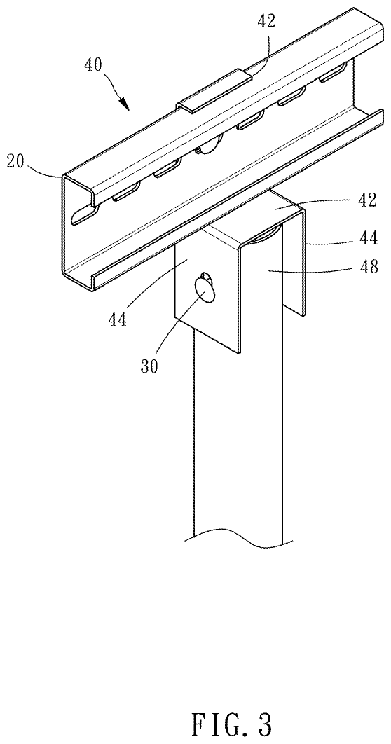

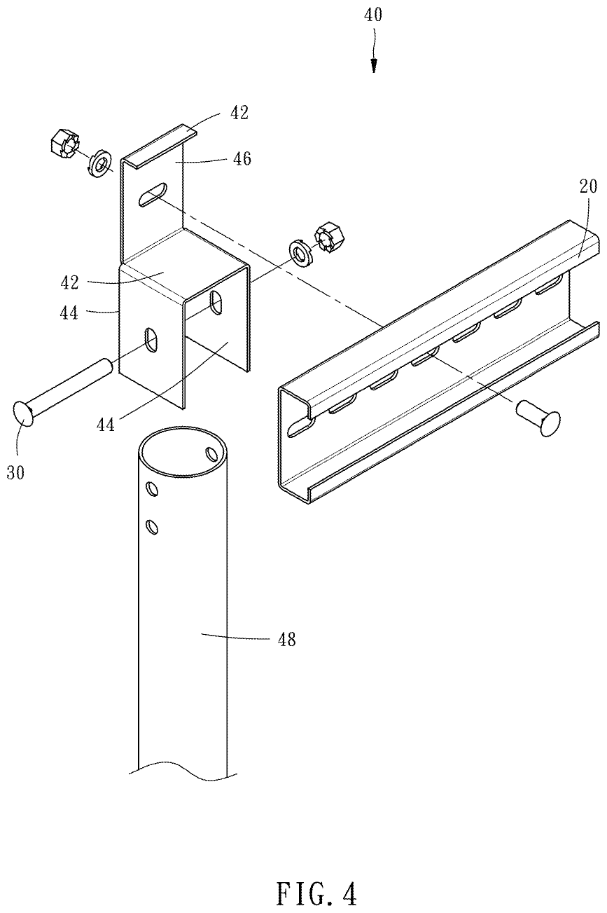

As shown in FIG. 3 and FIG. 4, in the second preferred embodiment of the present invention, a section-steel joint 40, similar to its counterpart as described in the first preferred embodiment, comprises an upright plate 12, two opposite and separate support portions 42, and a connecting portion 44. The section-steel joint 40 features two connecting portions 44 integratedly connected to two opposite sides of one of the support portions 42 so that an accommodating socket 46 is defined by the connecting portion 44 and the support portions 42. Where the steel beam 48 is a round tube, to assemble the components, the top of the steel beam 48 is first placed in the accommodating socket 46, and then fasteners 30 pass through the connecting portions 44 and the steel beam 48. In this manner, the section-steel joint 40 can similarly be fixed to the top of the steel beam 48 to further connect the section steel cross beam 20.

To sum up, the disclosed section-steel joint uses the specially designed positioning groove and connecting portions to allow the section steel cross beam and the steel beam to be positioned fast, and then fasteners can be used to fix all the components together, thereby making the assembling work more convenient.

In addition, the present invention may further allows the relative position and angle between the section-steel joint and the steel beam to be adjusted according to practical needs, so as to provide a solar power module assembled to the section steel cross beam with possibility of synchronous adjustment.

What is claimed is:

1. A section-steel joint, serving to fasten a section steel cross beam and a steel beam together, the section-steel joint comprising an upright plate, two opposite support portions, and a connecting portion, the two support portions being separated from each other and integratedly connected to the upright plate, so that a positioning groove is defined by the two support portions and the upright plate for positioning the section steel cross beam, and the connecting portion being located on one side of the positioning groove for positioning the steel beam.

2. The section-steel joint of claim 1, wherein the two support portions are parallel to and separated from each other while being integratedly connected to the upright plate, and the positioning groove extends transversely while being open at its lateral to receive and position the section steel cross beam.

3. The section-steel joint of claim 1, wherein the connecting portion integratedly extending downward from a bottom of the upright plate, and the upright plate is located on one side of the positioning groove, so that fasteners passing through the section steel cross beam and the steel beam before and then being fixed to the connecting portion and the upright plate can combine the section-steel joint with the section steel cross beam and the steel beam as a whole.

4. The section-steel joint of claim 1, wherein the connecting portion is integratedly connected to two opposite sides of one of the support portions, so that an accommodating socket is defined by the connecting portion and one of the support portions for accommodating the steel beam.

5. The section-steel joint of claim 1, wherein the steel beam is atop provided with two separated fixing tongues and the connecting portion is fixed to an inner lateral of one of the fixing tongues.

6. The section-steel joint of claim 1, wherein a relative angle of inclination is defined by the section-steel joint and the steel beam.
